(19) United States
(12) Patent Application Publication
(10) Pub. No.: US 2011/0011468 A1
(43) Pub. Date: Jan. 20, 2011

(54) Check valve for abrasive blaster pressure vessel

(76) Inventor: Phuong Taylor Nguyen, Richmond, TX (US)

Correspondence Address: Robert C. Curfiss, 19826 Sundance Drive, Humble, TX, 77346-1402, US

(21) Appl. No.: 12/011,339

(22) Filed: Jan. 26, 2008

(51) Int. Cl. F16K 15/00

(52) U.S. Cl. 137/513.7; 137/528

(57) ABSTRACT

A check valve is installed in the pressure flow line of an abrasive blaster of the type having a pop-up valve which opens under pressure and closes when depressurized to a predetermined level. The check valve is upstream of the pop-up valve and includes a having a valve chamber in communication with the pressure system for seating a valve mechanism adapted for opening and closing the valve chamber in response to the pressure level in the pressure system for closing the pressure system to back flow when the pressure in the system reaches a predetermined level.

### BACKGROUND OF THE INVENTION

1. Field of the Invention

The invention is generally related to abrasive blaster system and is specifically directed to a balancing system for controlling backflow of abrasive into the pressure system during blow down operations.

2. Discussion of the Prior Art

Abrasive blaster systems are well known. Typical abrasive blaster include the 1.5, 3.5, 6.5, 8, 10 and 20 cubic feet abrasive blasters manufactured and sold by Axxiom Manufacturing, Inc., Fresno, Tex., USA and sold under the brand name SCHMIDT. These systems include a pressure vessel or tank having two chambers, a pressure chamber and an abrasive chamber. In order for the system to operate properly, the pressure chamber and the abrasive chamber must be balanced. A pop-up valve in the pressure inlet pipe permits the system to automatically react to pressure changes by opening and closing a passageway between the abrasive chamber and the pressure chamber.

During blow down, when the system is depressurized, the pop-up valve closes the pressure inlet. This is primarily to prevent stray abrasive particles for flowing back into the pressure system. However, it has been determined that this is an inefficient method for closing the pressure system to back flow of some of the particles. Therefore, there is a need to further reduce the potential back flow of particles into the pressurization system during blow down and depressurization of the pressure chamber.

### SUMMARY OF THE INVENTION

The present invention is directed to the check valve assembly which is located in the pressure line for the pressure chamber of an abrasive blaster upstream of the mushroom pop-up valve. The check valve is positioned in the pressure system upstream of the pop-up valve and comprises a valve body having a valve chamber in communication with the pressure system for seating a valve mechanism and a valve mechanism seated in the valve chamber and adapted for opening and closing the valve chamber in response to the differential pressure level in the pressure system for closing the pressure system to back flow when the pressure in the system reaches a predetermined level.

In the preferred embodiment the check valve includes a bleed hole in the valve body which is always open. The valve mechanism is a ball check valve and the valve body includes a ball seat. A biasing system may be incorporated in the valve for normally biasing the ball valve into closing engagement with the ball seat.

The check valve assembly includes a body for housing the check valve mechanism, an outlet coupler and an inlet coupler. When the system is pressurized, the check valve opens and the pressurized fluid flows through the check valve permitting the mushroom pop-up to lift into the chamber. When the pressure is relieved, gravity permits the mushroom valve to retract.

The check valve of the subject invention substantially reduces the likelihood of back flow into the external system.

When the system is pressured up, the ball is lifted in the seat for permitting pressurized flow in normal fashion, lifting the mushroom pop-up valve. As the system blows down, and pressure drops, the ball drops into the seat and closes off the pressure system as soon as pressure is low enough to permit the ball to drop.

This is also the time when migrant abrasive particles tend to back flow into the system. The ball check valve prevents this occurrence.

In the preferred embodiment the bleed hole is provided in the valve body for balancing the system during low pressure conditions. This provides a balancing feedback function. Typically, the bleed hole is much smaller than the main valve bore.

The ball valve may be biased toward the seat by gravity or by other biasing means such as a compression spring or the like.

### BRIEF DESCRIPTION OF THE DRAWINGS

FIG. 1 is a cutaway view of a pressure vessel incorporating the check valve system of the subject invention.

FIG. 2 is a view of the pop-up valve in the down position, with the check valve at the lower end thereof

FIG. 3 is a view looking in the same direction as FIG. 2, with the pop-up valve in the up position.

FIG. 4 illustrates the pop-up valve, check valve and pipe assembly.

FIG. 5 is an exploded sectional view of the check valve assembly.

FIG. 6 is an exploded perspective view of the check valve assembly.

### DETAILED DESCRIPTION OF THE PREFERRED EMBODIMENTS

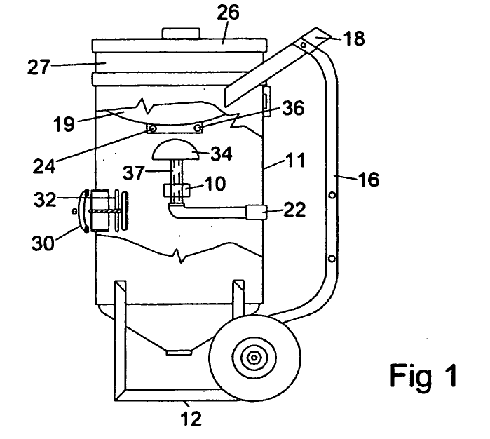

The check valve system 10 of the subject invention is adapted to be used in combination with the pressure vessel of an abrasive blaster system. As shown in FIG. 1, the pressure vessel 11 may be stationary or portable. When portable, the vessel 11 is mounted on a frame 12 having wheels 14, a load skid 16 by which the vessel may be stowed in a horizontal orientation, and a handle 18 for facilitating movement of the pressure vessel.

The pressure vessel 11 is subdivided into a plurality of chambers, and as here shown includes the upper chamber or pot 19 for holding the abrasive. The lower chamber 20 is the pressurized chamber. A source of pressurized fluid, typically air, is introduced into the vessel 11 and the pressure chamber 19 through an inlet pipe 22. The inlet pipe 22 is typically connected to piping and valves coupled to a source of pressurized air (not shown). The abrasive chamber 19 includes a lower inlet 24 through which the pressurized fluid flows to mix with the abrasive and force through a suitable outlet (not shown). Typically a lid 26 is provided for covering the abrasive chamber. However, the lid is not required for operation. Also, a screen 27 may be provided where desired. As the pressurized air enters the chamber via inlet 22 it drives the abrasive flow through outlet 23 to a metering valve (not shown) which is coupled to the outlet 23.

A blowdown or depressurizing outlet 25 is provided for depressurizing the entire system when off or as required for maintenance.

In most configurations a handway assembly 30 is provided and includes a sealing gasket 32. The handway assembly may be manually opened and closed for access to the pressure chamber 20 for cleaning and maintenance.

Pressurized fluid is introduced into the vessel through pipe 22. A mushroom pop-up valve 34 is located in the vertically oriented open end 37 of the inlet pipe. Typically, the mushroom head is made of a heavy, durable material such as, by way of example, polyurethane. The inlet 24 in the upper abrasive chamber 19 is adapted to mate with head 34 and is provided with a gasket 36 for substantially sealing the pressure chamber 20 from the abrasive chamber 19 when the system is fully pressurized. Specifically, as the pressurized fluid flows into the chamber 19 through the pipe 22, it lifts the pop-up valve upward and into closing contact with the gasket 36.

As is well known to those who are skilled in the art, the pressurized fluid flow introduced into the pipe 22 is also introduced into a control valve system (not shown) for controlling the release an abrasive and fluid mix through an application valve (also not shown).

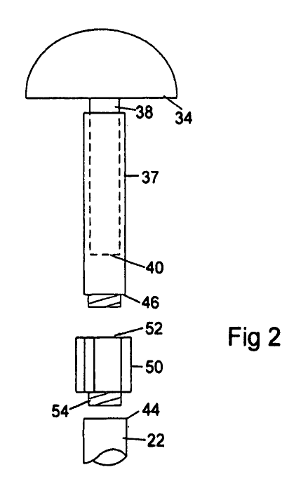

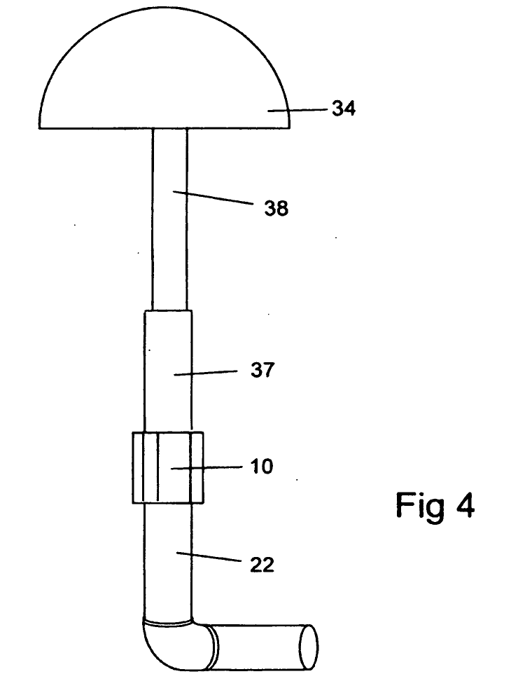

The present invention is directed to the check valve assembly 10 which is located in line in the pipe 22, and positioned in a vertical orientation just below the lower most position 40 of the stem 38 of the mushroom pop-up valve 34, see FIGS. 2, 3 and 4. As shown specifically shown in FIG. 2, the check valve assembly is located between the vertically oriented end 44 of inlet pipe 22 and the lower end 46 of outlet portion 37 of the pipe assembly. The check valve assembly includes a body 50 for housing the check valve mechanism, an outlet coupler 52 and an inlet coupler 54. In the illustrated embodiment the couplers are adapted to be mated with complementary ends in the pipes 22 and 37. However, it should be understood that any suitable coupling mechanism could be used, such as, by way of example, welding.

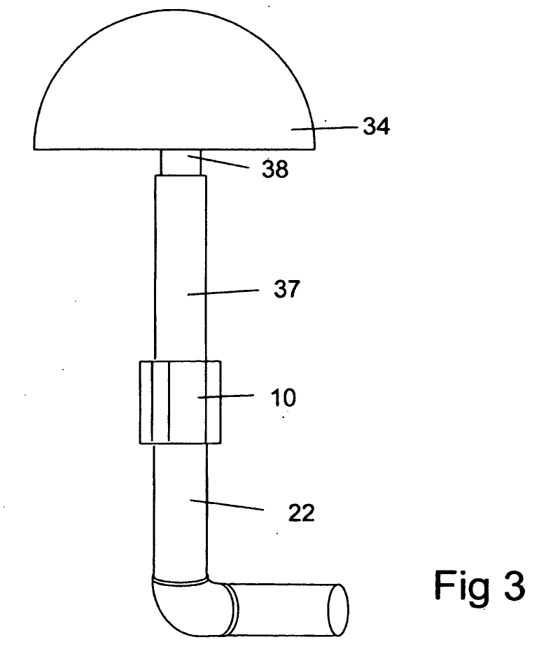

In operation, when the pipe 22 is pressurized, the check valve 10 opens and the pressurized fluid flows through the check valve and into the pipe 37. This lifts the mushroom pop-up valve 34 into engagement with the mushroom gasket 36 for closing off the abrasive chamber 19 from the pressure 20 (see FIGS. 1 and 3). When the pressure in pipe 22 is relieved, gravity permits the mushroom valve to retract into the pipe 37, with the mushroom head substantially closing off the upper end of pipe (see FIGS. 1, 3 and 4).

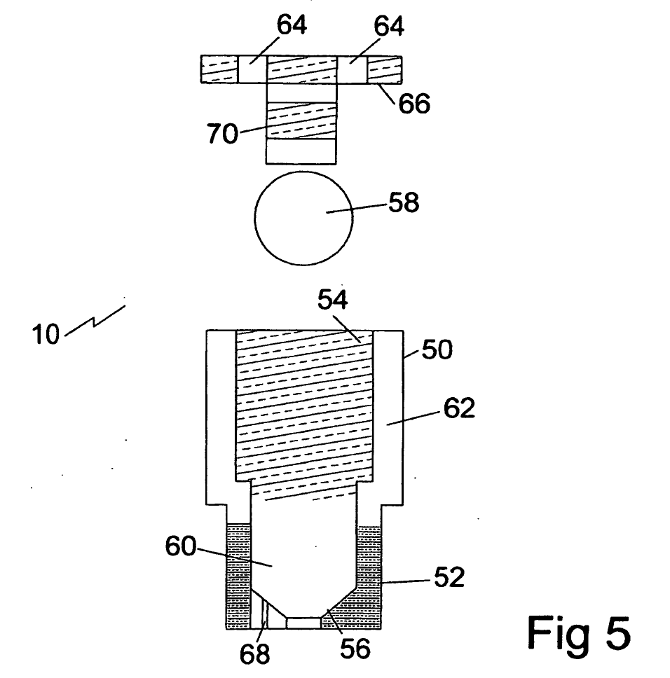

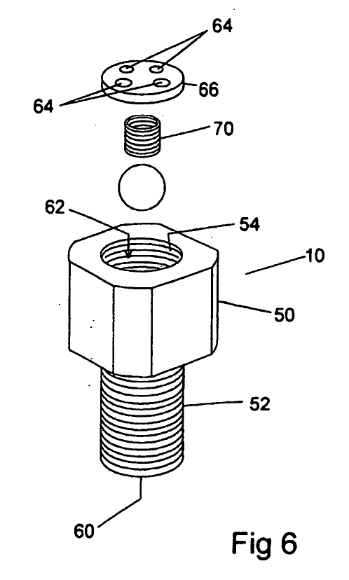

However, during the blow down period small amounts of abrasive may enter into the pipe 37 and as the system is depressurized abrasive material can backflow into the system outside of the tank 11, causing malfunction or damage. The check valve 10 substantially reduces the likelihood of back flow from pipes 37 and 20 into the external system. As specifically shown in FIGS. 5 and 6, the check valve assembly includes a body 50 with connector or coupler nipples 52 and 54. The body 50 includes a ball seat 56 for receiving the ball 58. Through flow through the valve body is provided by the central bore 60 in the inlet nipple 54, bore 62 in the body 50 and in communication with the ball seat 56. A retainer disc 66 is adapted to be received in the outlet end of the body 56 and secured in place for holding the ball 58 in the body 50. The retainer disc 66 includes one or more through holes 64.

When the system is pressured up, the ball 58 is lifted in the seat 56, opening the bore 62 and permitting the pressurized fluid to flow through pipe 22 and pipe 37 in normal fashion, lifting the mushroom pop-up valve 34, as previously described. As the system blows down, and pressure drops, the ball 58 drops into seat 54 and close off the bore 62 as soon as pressure is low enough to permit the ball to drop. This is also the time when migrant abrasive particles tend to back flow into the system. The ball check valve 10 prevents this occurrence.

In the preferred embodiment a bleed hole 68 is provided in the valve body 50 for balancing the system during low pressure conditions. This provides a balancing feedback function. Typically, the bleed hole 68 is much smaller than the main valve bore 62. It has been determined that a bleed hole having 1/100 the flow of the main bore 62 is sufficient to provide proper balancing feedback.

The ball valve 58 may be biased toward the seat 56 by gravity or, as shown in FIGS. 5 and 6, by a compression spring 70 which is also held in place by the retainer disc 66.

The incorporation of the check valve assembly 10 into the pressure circuit of the blaster system has reduced backflow of the abrasive into the system and reduced both maintenance and incidence of failure of the system. While certain embodiments and features of the invention have been shown and described in detail herein, it should be understood that the invention includes all modifications and enhancements within the scope and spirit of the following claims.

What is claimed is:

1. A check valve for a pressure system for pressurizing the pressure chamber of an abrasive blaster of the type having a pop-up valve which opens under pressure and closes when depressurized to a predetermined level, the check valve being positioned in the pressure system upstream of the pop-up valve, the check valve comprising:
a. a valve body having a valve chamber in communication with the pressure system for seating a valve mechanism; and
b. a valve mechanism seated in the valve chamber and adapted for opening and closing the valve chamber in response to the pressure level in the pressure system for closing the pressure system to back flow when the pressure in the system reaches a predetermined level.

2. The check valve of claim 1, further including a bleed hole in the valve body which is always open.

3. The check valve of claim 1, wherein the valve mechanism is a ball valve and the valve body includes a ball seat.

4. The check valve of claim 3, further including a biasing system for normally biasing the ball valve into closing engagement with the ball seat.

5. The check valve of claim 4, wherein the valve body includes a central bore and wherein the valve seat is in communication with the central bore, the check valve further including a retainer downstream of the ball valve for maintaining the ball valve in the valve body during operation.

6. The check valve of claim 4, wherein the cross-sectional area of the bleed hole is smaller than the cross-sectional area of the central bore.

7. The check valve of claim 6, wherein the cross-sectional area of the bleed hole is approximately 1/100 the cross-sectional area of the central bore.

8. A ball check valve for a pressure system for pressurizing the pressure chamber of an abrasive blaster of the type having a pop-up valve which opens under pressure and closes when depressurized to a predetermined level, the ball check valve being positioned in the pressure system upstream of the pop-up valve, the ball check valve further having a central bore therethrough in communication with the pressure stream in the system, the ball check valve comprising:
a. a valve body having a chamber including a ball seat
b. a ball valve mechanism seated in the valve chamber and adapted for opening and closing the valve chamber in response to the pressure level in the pressure system for closing the pressure system to back flow when the pressure in the system reaches a predetermined level;
c. a bleed hole in the valve body which is always open; and
d. a retainer in the valve body for retaining the ball valve mechanism in the chamber during operation.

9. The ball check valve of claim 8, further including a biasing system for normally biasing the ball valve mechanism into closing engagement with the ball seat.

10. The ball check valve of claim 8, wherein the cross-sectional area of the bleed hole is smaller than the cross-sectional area of the central bore.

11. The ball check valve of claim 10, wherein the cross-sectional area of the bleed hole is approximately 1/100 the cross-sectional area of the central bore.
